(19) United States
(12) Patent Application Publication
(10) Pub. No.: US 2008/0263342 A1
(43) Pub. Date: Oct. 23, 2008

(54) Apparatus and method for handling exception signals in a computing system

(75) Inventors: Paul Thomas Knowles, Manchester (GB); Kit Man Wan, Oldham (GB)

Correspondence Address: WILMERHALE/BOSTON, 60 STATE STREET, BOSTON, MA, 02109, US

(73) Assignee: Transitive Limited, London (GB)

(21) Appl. No.: 11/810,050

(22) Filed: Jun. 4, 2007

(30) Foreign Application Priority Data
Apr. 19, 2007 (GB) GB0707528.6

(51) Int. Cl. G06F 9/26

(52) U.S. Cl. 712/244; 712/E09.015

(57) ABSTRACT

Described is method and apparatus for handling exception signals in combination particularly with the dynamic conversion of binary code executable by a one computing platform into binary code executed instead by another computing platform. An exception handling unit selectively handles some exception signals with respect to a target state and handles others with respect to a subject state derived from the target state. Signal handling sub-units are arranged to process the exception signal with respect to the target state and output a request either to return to execution or to pass on the exception signal. A delivery path selection unit is arranged to determine a delivery path of the exception signal to a selected group of the plurality of signal handling sub-units. A signal control unit is arranged to deliver the exception signal in turn to each of the selected group of signal handling sub-units.

### FIELD OF THE INVENTION

The present invention relates generally to the field of computers and computer systems and, more particularly, to the handling of exception signals in the context of program code conversion methods and apparatus useful, for example, in code translators, emulators and accelerators. More particularly, the exemplary embodiments of the present invention relate to a method and apparatus for the handling of exception signals in combination with the dynamic conversion of binary code executable by a one computing platform into binary code executable instead by another computing platform.

### BACKGROUND OF THE INVENTION

The central processing unit (CPU) or processor lies at the heart of all modern computing systems. The processor executes instructions of a computer program and thus enables the computer perform useful work. CPUs are prevalent in all forms of digital devices in modern life and not just dedicated computing machines such as personal computers, laptops and PDAs. Modem microprocessors appear in everything from automobiles to cellular telephones to children's toys.

A problem arises in that program code which is executable by one type of processor often cannot be executed in any other type of processor, because each type of processor has its own unique Instruction Set Architecture (ISA). Hence, program code conversion has evolved to automatically convert program code written for one type of processor into code which is executable by another type of processor, or to optimise an old, inefficient piece of code into a newer, faster version for the same type of processor. That is, in both embedded and non-embedded CPUs, there are predominant ISAs for which large bodies of software already exist that could be “accelerated” for performance or “translated” to other processors that present better cost/performance benefits. One also finds dominant CPU architectures that are locked in time to their ISA and cannot evolve in performance or market reach. This problem applies at all levels of the computing industry, from stand-alone pocket-sized computing devices right through to massive networks having tens or hundreds of powerful servers.

As background information in this field of program code conversion, PCT publication WO2000/22521 entitled “Program Code Conversion”, WO2004/095264 entitled “Method and Apparatus for Performing Interpreter Optimizations during Program Code Conversion”, WO2004/097631 entitled “Improved Architecture for Generating Intermediate Representations for Program Code Conversion”, WO2005/006106 entitled “Method and Apparatus for Performing Adjustable Precision Exception Handling”, and WO2006/103395 entitled “Method and Apparatus for Precise Handling of Exceptions During Program Code Conversion”, which are all incorporated herein by reference, disclose methods and apparatus to facilitate program code conversion capabilities as may be employed in the example embodiments discussed herein.

One particular problem area concerns the handling of exception signals. An exception is a condition that changes the normal flow of control in a program. An exception signal indicates that a condition has occurred somewhere within the system that requires the attention of the processor and usually needs to be handled before processing can continue. Exceptions can be subdivided into various different types such as interrupts, faults, traps or aborts. The terminology varies between different architectures, and particular types or categories of exceptions may be unique to particular architectures.

Exception signals (often simply called “signals”) may be raised by hardware or by software. Hardware exceptions include such signals as resets, interrupts, or signals from a memory management unit. As examples, exceptions may be generated by an arithmetic logic unit or floating-point unit for numerical errors such as divide-by-zero, for overflow or underflow, or for instruction decoding errors such as privileged, reserved, trap or undefined instructions. Software exceptions vary greatly across various different software programs but generally are applied to any kind of error checking which alters the normal behaviour of the program.

A signal handler is special code which is called upon when an exception signal occurs during the execution of a program. The signal handler then attempts to deal with whatever circumstances gave rise to the exception and, if possible, continue execution of the program. If the program does not provide a signal handler for a given signal then a default system signal handler will be called.

The most common events that trigger exception signals are when a process tries to (i) access an unmapped memory region or (ii) manipulate a memory region for which it does not have the correct permissions. Other common events that trigger exception signals are (iii) receipt of a signal sent from another process, (iv) execution of an instruction that the current process does not have the privilege level to execute, or (v) an Input/Output event in the hardware.

Some representative exception signals are described in Table 1. From the perspective of the target computing platform, each type of signal has a corresponding signal number which is usually an integer number #1, #2, #3, etc. Also, as shown in the table, it is common for each signal to have a memorable symbolic name.

TABLE 1
Example Exception Signals

| SigNum | Signal | Description |
|---|---|---|
| #1 | SIGHUP | “Hangup” - commonly used to indicate to a process that its |
| | | configuration has changed, and that it should re-read its config file. |
| #2 | SIGINT | “Interrupt” - usually means Ctrl-C has been pressed by the user. |
| #3 | SIGILL | “Illegal Instruction” - the processor generates this when an invalid |
| | | instruction opcode is encountered. |
| #4 | SIGTRAP | “Breakpoint” - often used by debuggers. |
| #5 | SIGBUS | “Bus Error” - usually generated by the processor to indicate an |
| | | invalid memory access. This is usually an access to an unallocated or |
| | | unaligned memory address. |
| #6 | SIGSEGV | “Segmentation Violation” - generated by the processor when a user |
| | | process has tried to do something not permissible in user mode. For |
| | | example, trying to execute a privileged instruction, or trying to write |
| | | to part of the kernel memory would both raise this signal. |
| #7 | SIGALRM | “Alarm Clock” - a process can make an alarm( ) system call, which |
| | | requests the delivery of this signal n seconds later. |
| #8 | SIGTERM | “Terminate” - polite request for a program to think about exiting, if |
| | | it's not too inconvenient. |
| #9 | SIGQUIT | “Quit” - Firm request for a program to exit, now please! |
| #10 | SIGKILL | “Die” - immediately terminates the process. This signal cannot be |
| | | intercepted by a signal handler. |

Exception signals can come from two sources: (I) directly from an executing program or (2) from the operating system or another process. Some exception signals are generated as a direct result of an instruction executed by the program. For example, if a program executes an illegal opcode, then SIGILL is raised. Similarly, if the program attempts an illegal memory access the SIGSEGV is raised. These are referred to as in-band signals. Exception signals can also be generated externally,, either by the operating system or by another process. SIGHUP and SIGALRM are examples of these. These externally generated exception signals are called out-of-band signals.

From a program's point of view, an exception signal can occur at any time. When an exception signal occurs, the operating system interrupts the execution of the signaled program and invokes a signal handler. The operating system usually defines default signal handlers for all exceptions which receive the exception signals by default and either take predefined actions or simply ignore the signal. However, the operating system maintains a process-specific handling table which maps each type of signal to a registered signal handler. For example, in Unix, a program can override a default signal handler by invoking a sigaction( ) system call. Sigaction( ) allows the program to specify what action the operating system should take when a particular exception signal is received. The action can be: (1) ignore the exception signal; (2) call the default signal handler; or (3) call a specialized signal handler function, whose address is provided by the program. Other options that can be specified when making the sigaction( ) call include which other signals are blocked during execution of a signal handler, in much the same way as a CPU can mask certain interrupts.

A Unix signal handler is typically provided with one of two prototypes. The first signal handler prototype is “void sigHandler(int sigNum).” The first argument is the number of the exception signal, so that one function can be registered to handle multiple signals. A program can request that more information be provided to the signal handler by calling sigaction( ) with the SA_SIGINFO flag. In this case, the Unix signal handler prototype becomes “void sigHandler(int sigNum, siginfo_t sigInfo, void *context).”

The second parameter (“siginfo”) is a structure which contains information about the signal, including some indication of what caused the signal and where it came from. For example, in the case of a SIGILL signal, the siginfo structure contains the address of the illegal instruction. This data can be essential to allow the process to handle the signal properly. The third parameter (“context”) provides access to the processor state (including all registers) at the time the signal was raised. Again, this data can be essential to allow correct handling of a signal. The signal handler is allowed to modify this context and, when execution is resumed, the registers are then restored to the values of the modified context.

Where the original program code (here called “subject code”) has been written according to a particular type of processor, then that subject code requires a particular type of execution environment and must be supported by an appropriate mechanism for the handling of exception signals. However, under program code conversion, the subject code is instead converted into target code and is executed on a target computing system. When an exception arises, there is now a difficulty in providing an appropriate mechanism to handle the exception.

In the field of program code conversion, it is apparent that when a target instruction is executed on a target processor and causes an exception signal to be reported, the target instruction generally will not fulfil the conditions for reporting an exception to a signal handler written in subject code. Instructions are almost always performed on the target processor in a different order to the order of instructions in the corresponding block of subject code, firstly due to the differences between the instruction set of the subject processor for which the subject code was written and the target processor on which the target code is run, and secondly because of the optimisations that typically occur during program code conversion. Hence, it is relatively easy to provide a target state to a signal handler, but it is difficult and costly to obtain an accurate subject state representing an equivalent point in execution of the original subject code.

A further problem arises in particularly in the field of dynamic program code conversion where execution of the translator which performs the program code conversion and execution of the target code generated by the translator are interleaved and may even share the same execution process on the target computing platform. In most systems there are only a limited number of exception signals. For example, there is only one SIGALRM signal which then may need to be shared between the translator and the target code. As a result, it is difficult for the target code to accurately emulate the original subject code without adversely affecting execution of the translator, or conversely it difficult for the translator target code to efficiently perform program code conversion without adversely affecting execution of the target code. The available signals in the target computing platform may become exhausted and, in the worst case, the program code conversion process must be terminated.

A yet further problem arises in that the subject code may have been written to make extensive use of signals, which cannot now be supported by the number or type of signals which are available on the target computing platform.

These and other problems of the prior art are addressed by the exemplary embodiments of the present invention as will be discussed in more detail below.

### SUMMARY OF THE INVENTION

According to the present invention there is provided an apparatus and method as set forth in the appended claims. Other features of the invention will be apparent from the dependent claims, and the description which follows.

The following is a summary of various aspects and advantages realizable according to embodiments of the invention. It is provided as an introduction to assist those skilled in the art to more rapidly assimilate the detailed discussion that follows and does not and is not intended in any way to limit the scope of the claims that are appended hereto.

In particular, the inventors have developed methods directed at program code conversion, which are particularly useful in connection with a run-time translator that provides dynamic run-time translation or acceleration of binary program code.

In one exemplary aspect of the present invention there is provided a computing system, comprising: a translator unit arranged to convert subject code into target code; a processor unit arranged to execute the target code and provide a target state with respect to execution of the target code in the processor unit; a signal generator unit arranged to generate exception signals at least in response to execution of the target code; and an exception handling unit arranged to handle the exception signal.

According to an aspect of the invention, the exception handling unit includes a target-side exception handler unit arranged to receive one of the exception signals from the signal generator unit and to selectively handle the exception signal with respect to the target state; and a subject-side exception handler unit arranged to receive the exception signal from the target-side exception handling unit and to handle the exception signal with respect to a subject state derived from the target state.

According to an aspect of the invention, the target-side exception handler unit comprises a plurality of signal handling sub-units each arranged to selectively process the exception signal with respect to the target state and output a request either to return to execution or to pass on the exception signal; a delivery path selection unit arranged to determine a delivery path of the exception signal to a selected group of the plurality of signal handling sub-units; and a signal control unit arranged to deliver the exception signal in turn to each of the selected group of signal handling sub-units according to the delivery path and (i) where a respective one of the signal handling sub-units requests the return to execution then to return to execution according to the target state; and (ii) where the signal handling sub-unit requests to pass on the exception signal then to pass on the exception signal to a subsequent one of the selected group of signal handling sub-units according to the delivery path and, where no further of the signal handling sub-units are specified in the delivery path, then to deliver the exception signal to the subject-side exception handler unit.

In another aspect of the present invention there is provided a method of handling an exception signal in a computing system having at least one processor, the method comprising the computer-implemented steps of: converting subject code into target code executable by the at least one processor; executing the target code on the at least one processor; generating an exception signal in relation to execution of the target code; determining a signal delivery path with respect to the exception signal where the signal delivery path specifies a group of signal handling sub-units selected from amongst a plurality of signal handling sub-units; delivering the exception signal to a first of the signal handling sub-units in the group according to the signal delivery path; determining whether to process the signal in the signal handling sub-unit and if so then processing the signal in the signal handling sub-unit to handle the exception; and deciding whether to request a return to execution and if so then returning to execution; or else passing the exception signal to a next signal handling sub-unit of the group according to the signal delivery path and repeating the determining and deciding steps in relation to the next signal handling sub-unit.

In yet another aspect of the present invention there is provided a method of handling an exception signal in a computing system, comprising the computer-implemented steps of: converting subject code executable by a subject processor type into target code executable by at least one processor; executing the target code in the at least one processor; generating an exception signal in relation to execution of the target code; determining whether or not to handle the exception signal solely with reference to a target state data structure containing information representing a state of execution of the computing system in relation to the exception signal; and if not, then converting the target state data structure into a subject state data structure containing information representing an emulated state of execution of the subject code on the subject processor type relating to the exception signal and handling the exception signal with respect to the subject state data structure.

The exemplary embodiments handle at least some types of exception signals solely with reference to the target state and thus reduce the number of occasions when the target state must be converted into the subject state. As a result, the computing system is now able to execute faster and more efficiently.

Further, the exemplary embodiments of the invention are arranged to deliver certain types of exception signals to multiple signal handling sub-units, each of which then has the opportunity to examine and handle the exception. A single exception signal is thus exposed for multiple different purposes. This mechanism allows a single type of exception signal—such as an alarm signal—to be shared between the target code and the translator.

Further still in the exemplary embodiments discussed herein, subject code which makes extensive use of signals is readily supported now when converted to target code and executed on the target computing platform, even though the target computing platform may have significantly different numbers or types of exception signals.

The present invention also extends to a computer-readable storage medium having instructions recorded thereon which when implemented by a computer system perform any of the methods defined herein.

At least some embodiments of the invention may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks. Alternatively, elements of the invention may be configured to reside on an addressable storage medium and be configured to execute on one or more processors. Thus, functional elements of the invention may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Further, although the preferred embodiments have been described with reference to the components, modules and units discussed below, such functional elements may be combined into fewer elements or separated into additional elements.

### BRIEF DESCRIPTION OF THE DRAWINGS

The accompanying drawings, which are incorporated in and constitute a part of the specification, illustrate presently preferred implementations and are described as follows:

FIG. 1 is a block diagram illustrative of apparatus wherein embodiments of the invention find application;

FIG. 2 is a schematic overview of a program code conversion process as employed by embodiments of the present invention;

FIG. 3 is a schematic diagram illustrating control flow during exception handling in exemplary embodiments of the present invention;

FIG. 4 is a schematic diagram illustrating parts of an exemplary computing system relating to exception handling;

FIG. 5 is a schematic diagram illustrating an exemplary signal handling sub-unit;

FIG. 6 is a schematic flow diagram illustrating a method of handling exception signals according to exemplary embodiments of the present invention;

FIG. 7 is a schematic diagram illustrating parts of an exemplary computing system relating to exception handling;

FIG. 8 is a schematic flow diagram illustrating a further method of handling exception signals according to exemplary embodiments of the present invention;

FIG. 9 is a schematic diagram further illustrating parts of an exemplary computing system relating to exception handling;

FIG. 10 is another schematic diagram illustrating parts of an exemplary computing system relating to exception handling;

FIG. 11 is a schematic diagram further illustrating parts of an exemplary computing system relating to exception handling;

FIG. 12 is another schematic diagram further illustrating parts of an exemplary computing system relating to exception handling.

### DETAILED DESCRIPTION

The following description is provided to enable a person skilled in the art to make and use the invention and sets forth the best modes contemplated by the inventors of carrying out their invention. Various modifications, however, will remain readily apparent to those skilled in the art, since the general principles of the present invention have been defined herein specifically to provide an improved program code conversion method and apparatus.

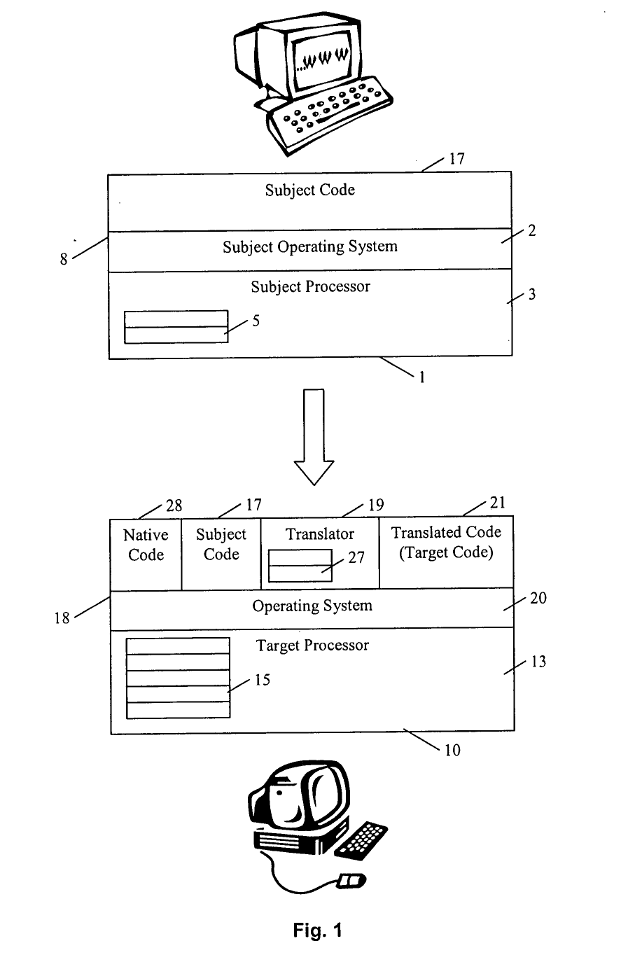

FIG. 1 gives an overview of a system and environment where the example embodiments of the present invention may find application, in order to introduce the components, modules and units that will be discussed in more detail below. Referring to FIG. 1, a subject program 17 is intended to execute on a subject computing platform 1 having at least one subject processor 3. However, a target computing platform 10 is instead used to execute the subject program 17, through a translator unit 19 which performs program code conversion. The translator unit 19 performs code conversion from the subject code 17 to target code 21, such that the target code 21 is executable on the target computing platform 10.

As will be familiar to those skilled in the art, the subject processor 3 has a set of subject registers 5. A subject memory 8 holds, inter alia, the subject code 17 and a subject operating system 2. Similarly, the example target computing platform 10 in FIG. 1 comprises at least one target processor 13 having a plurality of target registers 15, and a memory 18 to store a plurality of operational components including a target operating system 20, the subject code 17, the translator code 19, and the translated target code 21. The target computing platform 10 is typically a microprocessor-based computer or other suitable computer.

In one embodiment, the translator code 19 is an emulator to translate subject code of a subject instruction set architecture (ISA) into translated target code of another ISA, with or without optimisations. In another embodiment, the translator 19 functions as an accelerator for translating subject code into target code, each of the same ISA, by performing program code optimisations.

The translator code 19 is suitably a compiled version of source code implementing the translator, and runs in conjunction with the operating system 20 on the target processor 13. It will be appreciated that the structure illustrated in FIG. 1 is exemplary only and that, for example, software, methods and processes according to embodiments of the invention may be implemented in code residing within or beneath an operating system 20. The subject code 17, translator code 19, operating system 20, and storage mechanisms of the memory 18 may be any of a wide variety of types, as known to those skilled in the art.

In the apparatus according to FIG. 1, program code conversion is performed dynamically, at run-time, to execute on the target architecture 10 while the target code 21 is running. That is, the translator 19 runs inline with the translated target code 21. Running the subject program 17 through the translator 19 involves two different types of code that execute in an interleaved manner: the translator code 19; and the target code 21. Hence, the target code 21 is generated by the translator code 19, throughout run-time, based on the stored subject code 17 of the program being translated.

In one embodiment, the translator unit 19 emulates relevant portions of the subject architecture 1 such as the subject processor 3 and particularly the subject registers 5, whilst actually executing the subject program 17 as target code 21 on the target processor 13. In the preferred embodiment, at least one global register store 27 is provided (also referred to as the subject register bank 27 or abstract register bank 27). In a multiprocessor environment, optionally more than one abstract register bank 27 is provided according to the architecture of the subject processor. A representation of a subject state is provided by components of the translator 19 and the target code 21. That is, the translator 19 stores the subject state in a variety of explicit programming language devices such as variables and/or objects. The translated target code 21, by comparison, provides subject processor state implicitly in the target registers 15 and in memory locations 18, which are manipulated by the target instructions of the target code 21. For example, a low-level representation of the global register store 27 is simply a region of allocated memory. In the source code of the translator 19, however, the global register store 27 is a data array or an object which can be accessed and manipulated at a higher level.

The term “basic block” will be familiar to those skilled in the art. A basic block is a section of code with exactly one entry point and exactly one exit point, which limits the block code to a single control path. For this reason, basic blocks are a useful fundamental unit of control flow. Suitably, the translator 19 divides the subject code 17 into a plurality of basic blocks, where each basic block is a sequential set of instructions between a first instruction at a single entry point and a last instruction at a single exit point (such as a jump, call or branch instruction). The translator 19 may select just one of these basic blocks (block mode) or select a group of the basic blocks (group block mode). A group block suitably comprises two or more basic blocks which are to be treated together as a single unit. Further, the translator may form iso-blocks representing the same basic block of subject code but under different entry conditions.

In the preferred embodiments, trees of Intermediate Representation (IR) are generated based on a subject instruction sequence, as part of the process of generating the target code 21 from the original subject program 17. IR trees are abstract representations of the expressions calculated and operations performed by the subject program. Later, the target code 21 is generated (“planted”) based on the IR trees. Collections of IR nodes are actually directed acyclic graphs (DAGs), but are referred to colloquially as “trees”.

As those skilled in the art may appreciate, in one embodiment the translator 19 is implemented using an object-oriented programming language such as C++. For example, an IR node is implemented as a C++ object, and references to other nodes are implemented as C++ references to the C++ objects corresponding to those other nodes. An IR tree is therefore implemented as a collection of IR node objects, containing various references to each other.

Further, in the embodiment under discussion, IR generation uses a set of register definitions which correspond to specific features of the subject architecture upon which the subject program 17 is intended to run. For example, there is a unique register definition for each physical register on the subject architecture (i.e., the subject registers 5 of FIG. 1). As such, register definitions in the translator may be implemented as a C++ object which contains a reference to an IR node object (i.e., an IR tree). The aggregate of all IR trees referred to by the set of register definitions is referred to as the working IR forest (“forest” because it contains multiple abstract register roots, each of which refers to an IR tree). These IR trees and other processes suitably form part of the translator 19.

FIG. 1 further shows native code 28 in the memory 18 of the target architecture 10. There is a distinction between the target code 21, which results from the run-time translation of the subject code 17, and the native code 28, which is written or compiled directly for the target architecture. In some embodiments, a native binding is implemented by the translator 19 when it detects that the subject program's flow of control enters a section of subject code 17, such as a subject library, for which a native version of the subject code exists. Rather than translating the subject code, the translator 19 instead causes the equivalent native code 28 to be executed on the target processor 13. In example embodiments, the translator 19 binds generated target code 21 to the native code 28 using a defined interface, such as native code or target code call stubs, as discussed in more detail in published PCT application WO2005/008478, the disclosure of which is incorporated herein by reference.

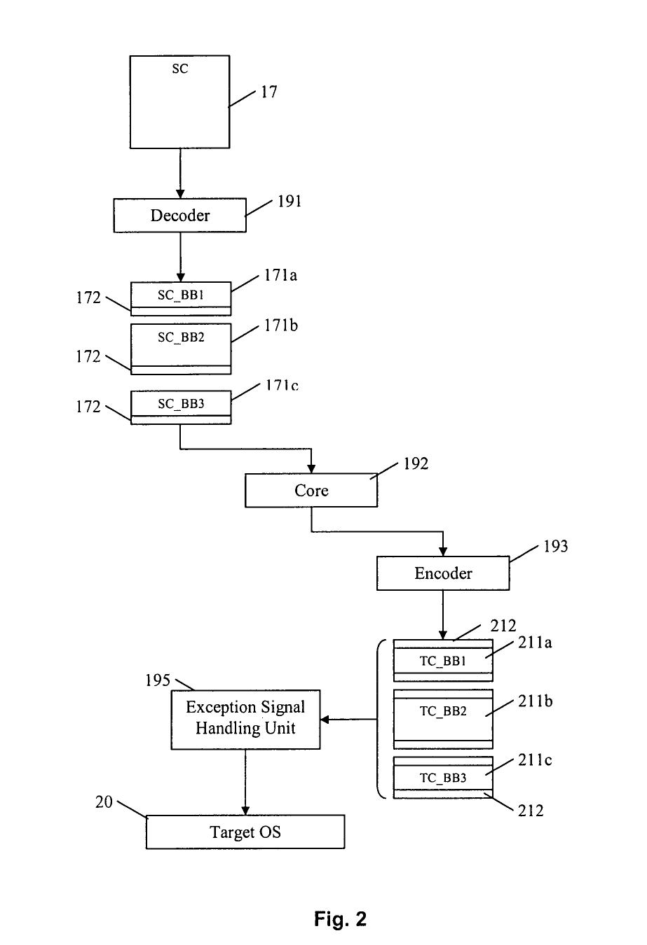

FIG. 2 illustrates the translator unit 19 in more detail when running on the target computing platform 10. As discussed above, the front end of the translator 19 includes a decoder unit 191 which decodes a currently needed section of the subject program 17 to provide a plurality of subject code blocks 171a, 171b, 171c (which usually each contain one basic block of subject code), and may also provide decoder information 172 in relation to each subject block and the subject instructions contained therein which will assist the later operations of the translator 19. In some embodiments, an IR unit in the core 192 of the translator 19 produces an intermediate representation (IR) from the decoded subject instructions, and optimisations are opportunely performed in relation to the intermediate representation. An encoder 193 as part of the back end of the translator 19 generates (plants) target code 21 executable by the target processor 13. In this simplistic example, three target code blocks 211a-211c are generated to perform work on the target platform 10 equivalent to executing the subject code blocks 171a-171c on the subject platform 1. Also, the encoder 193 may generate control code 212 for some or all of the target code blocks 211a-211c which performs functions such as setting the environment in which the target block will operate and passing control back to the translator 19 where appropriate.

As also shown in FIG. 2, the translator 19 is arranged to handle exception signals that are raised during execution of the target code 21. To this end, the translator 19 includes an exception handling unit 195 which is arranged to handle exception signals which are raised during execution of the target code 21 by the target processor 13. Further, in the exemplary embodiments, the same exception handling unit 195 is also arranged to handle exception signals raised while the translator 19 is executing on the target processor 13.

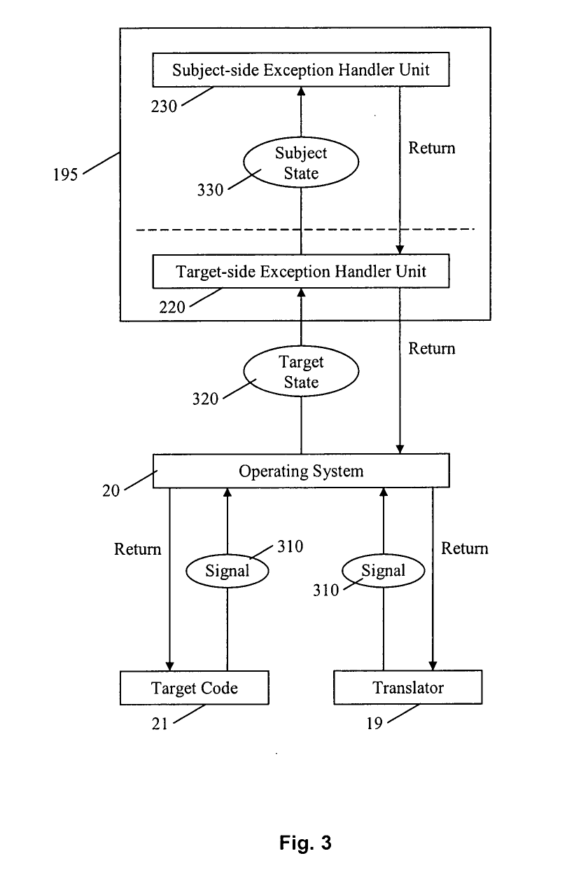

FIG. 3 is a schematic diagram illustrating, in general overview, control flow on the target computing platform 10 during signal handling using the exception handling unit 195. Here, the exception handling unit 195 includes a target-side exception handler unit 220 and a subject-side exception handler unit 230.

When a signal 310 arises, the target operating system 20 invokes the exception handling unit 195. A target state 320 represents, generally, the state of execution on the target processor 13. Thus, the target state 320 includes information about the exception signal 31 0 such as a SIGINFO data structure provided by the operating system 20. Further, the target state 320 optionally includes more detailed information about in particular the state of the target registers 15, at the point where the signal was raised, such as a SIGCONTEXT data structure. Thus, the exception handling unit 195 uses the target state 320 to examine the state of execution on the target processor 13 at the point where the exception signal 310 occurred.

There are various outcomes which can result from handling of the exception signal 310. In many cases it is possible to resume execution of the target code 21 and/or the translator 19 as appropriate. In particular, the exception handling unit 195 examines the target state 320 to determine the nature and cause of the exception and take appropriate responsive action. The exception handling unit 195 will, if appropriate, modify the target state 320, such as by changing a condition code flag or modifying stored data representing the contents of one or more of the target registers 15, before passing execution control back through the operating system 20 to resume execution according to the original or now-modified target state 320. Thus, execution may resume at the original point where the exception occurred, or may resume at a different point in the code, or in a different way, in response to the conditions which lead to the exception signal 310. In particular, an exception may arise during execution of the target code 21 but, after handling the exception, result in a return to execution of the translator 19 because the exception has indicated that the translator 19 now needs to change or regenerate one or more blocks of the target code 21.

The exception handling unit 195 handles many such exception signals 310 solely in the target-side exception handler unit 220 and only with reference to the target state 320. However, some exception signals are not handled by the target-side exception handler unit 220 alone. Here, a subject state 330 is provided which represents a state of execution on the emulated subject processor 3, including in particular representative values for the subject registers 5. Suitably, the subject state 330 makes reference to the one or more abstract register banks 27 discussed above. This subject state 330 is then employed by the subject-side exception handler unit 330 to handle the exception signal. However, it is relatively costly for the exception handler unit 195 to provide the subject state 330 and invoke the subject-side exception handler unit 230, and thus it is desired to minimise the occasions where the subject-side exception handler unit 230 in invoked and the subject state 330 constructed.

As with the target state 320, the subject state 330 may remain the same or may be modified in response to the exception signal 310. This modified subject state 330 typically then results in a corresponding modified target state 320 which causes the target code 21 or the translator 19 to restart execution at a different point or in a different manner.

The subject code 17 will often include one or more signal handler functions. That is, a particular program written in the subject code 17 will often include one or more specific signal handler functions which are to be invoked when specific exception signals arise. Now, instead, the exception signals 310 arise on the target platform and, where appropriate, information representing the subject exception handler is passed to the subject-side exception handler unit 230. The appropriate subject signal handler function is called through the subject-side exception handler unit 230 and executed (as target code) to handle the exception signal. Thus, the subject state 330 may include a subject SIGINFO data structure if that data structure is used by the subject signal handler. Likewise, a subject SIGCONTEXT data structure is populated from information available on the target system if that data structure is used by the subject signal handler. More detailed background information concerning the generation of such a subject state 330 is given in WO2005/006106 entitled “Method and Apparatus for Performing Adjustable Precision Exception Handling”, and WO2006/103395 entitled “Method and Apparatus for Precise Handling of Exceptions During Program Code Conversion” referenced above. Notably, these earlier disclosures consider a mechanism to provide the subject state at varying levels of precision for different subject instructions or an efficient mechanism to derive a precise subject state using recovery information, but do not allow for the handling of some exception signals solely with reference to the target state 320.

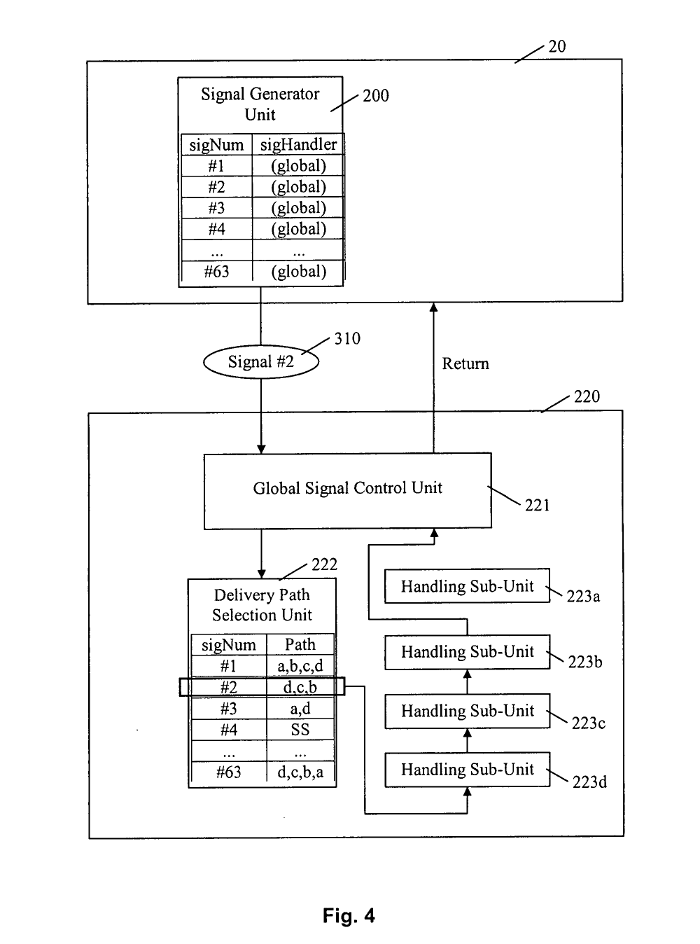

FIG. 4 is a schematic diagram illustrating specific parts of the target computing platform in more detail, including in particular the target-side exception handler unit 220.

As shown in FIG. 4, a signal generator unit 200, which is suitably part of the operating system 20, is arranged to generate exception signals in response to execution of, amongst other processes, the target code 21 or the translator 19 on the target processor 13. In a multi-process or multi-threaded computing environment there are many processes executing simultaneously, and the signal generator is responsible for raising exception signals for each process and delivering the exception signals to the respective registered handlers.

The target-side exception handler unit 220 comprises a global signal control unit 221, a delivery path selection unit 222, and a plurality of signal handling sub-units 223.

The global signal control unit 221 is arranged to receive the exception signals raised by the signal generator unit 200 at least in relation to execution of the target code 21 and most suitably also in relation to execution of the translator 19. That is, the global signal control unit 221 receives in-band exception signals for these processes. Further, the global signal control unit 221 is arranged to receive out-of-band exception signals which originate elsewhere in the system and are delivered to these processes.

The delivery path selection unit 222 determines a delivery path of each exception signal, where the delivery path specifies one or more of the plurality signal handling sub-units 223 that will receive the exception signal. The global signal control unit 221 then passes the exception signal to the or each of specified one or more the signal handling sub-units 223 in turn according to the particular delivery path for that exception signal.

That is, the signal control unit 221 selects a first one of the signal handling sub-units 223 according to the delivery path and passes the exception signal to that sub-unit. Then, the signal control unit 221 selects a second one of the signal handling sub-units 223 according to the delivery path and passes the exception signal to that sub-unit, and so on until the exception signal has been delivered in turn to each of the specified sub-units. In some multi-threaded computing environments it is possible that the exception signal is delivered to multiple units simultaneously or is delivered to a second sub-unit whilst the first is still actively processing the signal. However, since each of the sub-units will handle the signal and may take action such as changing the target state 320, it is preferred to treat the sub-units as following a linear path. In particular, the second sub-unit should not change the target state 320 until handling of the exception signal has been completed by the first sub-unit.

FIG. 4 shows an exemplary situation where the target computing system 10 supports a plurality of different types of exception signals, and each signal has a corresponding signal number (SIGNUM). The exception handling unit 195 is registered to receive a plurality of these signal types, and in this example the exception handling unit 195 is registered to receive each of the available set of signal types. As shown in FIG. 4, the signal generation unit 200 may use a signal table which registers the exception handling unit 195 to receive each of the available set of signals #1 to #63. Thus, when any of these signals are raised, the exception signal is passed to the exception handling unit 195.

As an example, let us assume that signal #2 has been raised. The global signal control unit 221 consults the delivery path selection unit 222 which specifies the particular delivery path for this signal. Here, the delivery path specifies which one or more of the illustrated signal handling sub-units 223a to 223d will receive the signal #2 and also specifies the order in which the selected group of signal handling sub-units 223 will receive the exception signal #2. In this example, the selected group of signal handling sub-units comprises units 223b, 223c and 223d and the order is specified as “d then c then b”. Thus, the global signal control unit 221 now passes the exception signal #2 first to the signal handling sub-unit 223d, then 223c, then 223b in turn.

Where one of the signal handling sub-units 223 requests a return to execution (in this case the third sub-unit 223b), the global signal control unit 221 completes handling of the signal and instigates a return to execution of the target code 21 or the translator 19 as appropriate.

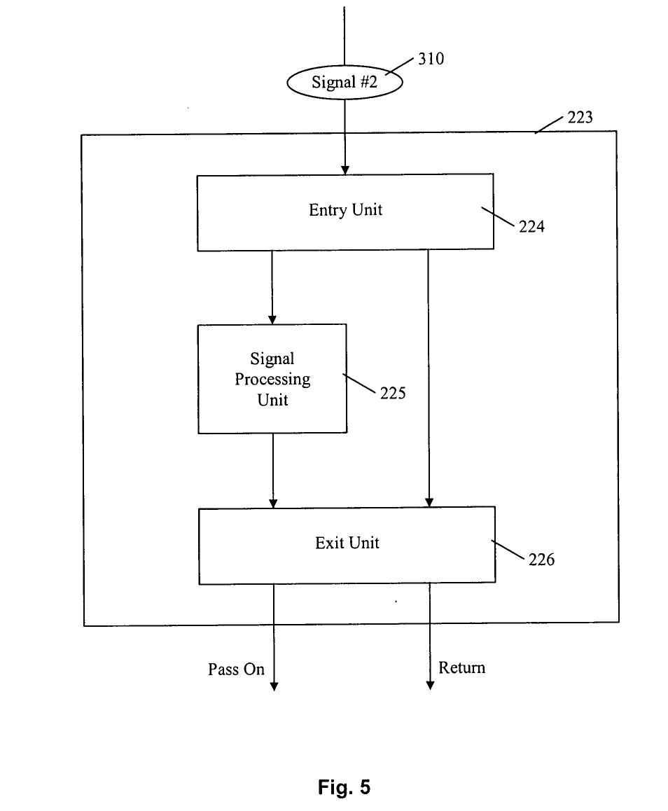

FIG. 5 is a schematic diagram illustrating one of the signal handling sub-units 223 in more detail.

As shown in FIG. 5, each of the signal handling sub-units 223 comprises an entry unit 224, a signal processing unit 225, and an exit unit 226. The entry unit 224 receives the signal 310 and determines whether this signal is to be processed by the signal processing unit 225. If yes, then the entry unit 224 passes the signal 310 to the signal processing unit 225. If not, then the entry unit 224 passes the signal 310 directly to the exit unit 226. Here, the entry unit 224 examines to the target state 320 to determine whether or not the exception signal is to be processed this time. In most cases, the determination is made by referring to the information provided in relation to the signal 310, such as the signal number or the SIGINFO data structure. Sometimes, however, the determination refers to more detailed context information from the target state 320 such as the SIGCONTEXT data structure.

The signal processing unit 225 performs a predetermined signal processing function on the received exception signal. That is, the signal processing unit 225 processes the signal in order to, at least in part, handle the exception. Optionally, the signal processing unit 225 will modify the target state 320 such that execution will resume differently in response to the handled exception signal.

The exit unit 226 determines whether the signal 310 is now to be passed on to a subsequent signal handling sub-unit 223 (or other unit as will be discussed in more detail below), or else that execution should resume according to the target state 320.

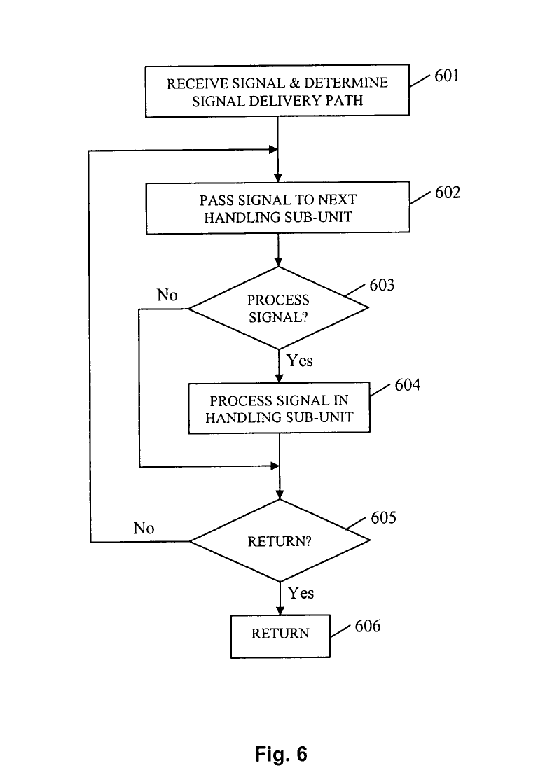

FIG. 6 is a schematic flow diagram illustrating a method of handling an exception as undertaken by the signal handling unit 195 and particularly in the target-side exception handler unit 220 and the one or more signal handling sub-units 223.

The exception signal is received at step 601 and a signal delivery path is determined. At step 602, the signal is then passed to a signal handling sub-unit according to the signal delivery path. At step 603 it is determined whether or not to process the signal. If yes, then the signal is processed at step 604. A decision is made at step 605 whether or not to request a return to execution. If no, then the method reverts to step 602 and the signal is passed to the next signal handling sub-unit. Thus, the signal 310 is passed in turn to the first, second, third and subsequent signal handling sub-units according to the signal delivery path. Where a return to execution is requested at step 605, then execution control is returned according to the stored target state 320 at step 606.

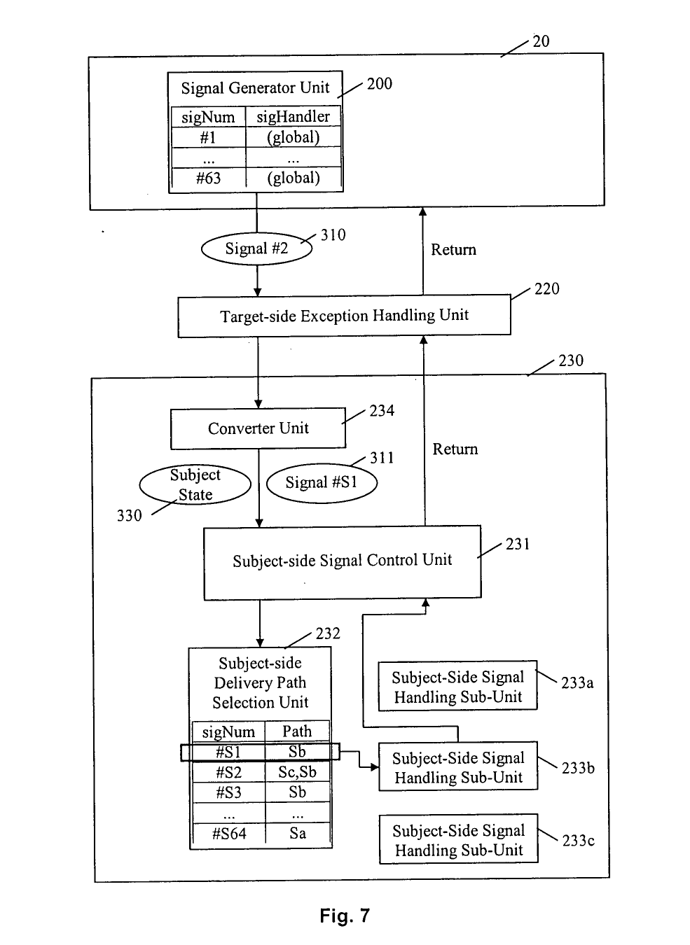

FIG. 7 is a schematic diagram showing the subject-side exception handler unit 230 in more detail.

As shown in FIG. 7, the subject-side exception handler unit 230 comprises a subject-side signal control unit 231, a subject-side delivery path selection unit 232, a set of subject-side signal handling sub-units 233a-233c, and a converter unit 234.

The converter unit 234 is arranged to convert the exception signal into a format expected on the subject architecture, i.e. into a subject-side exception signal 311. In particular, fields such as the signal number (SIGNUM) often differ between target and subject architectures. In this example, signal #2 on the target-side has been translated to signal #S1 on the subject-side. Also the converter unit 234 provides the precise subject state 330 ready for handling of the subject-side exception signal 311. In particular, the converter unit 234 converts the target state 320 representing the state of execution on the target machine to provide the subject context data structure SIGCONTEXT ready for handling of the exception in the subject-side exception handler unit. Conversely, the converter unit 234 later converts the modified subject state 330 back into the equivalent target state 320 to resume execution in the modified target state.

The subject-side delivery path selection unit 232 determines a delivery path for the exception signal amongst one or more of the subject-side signal handling sub-units 233a-c. In this case, the signal delivery path specifies that the exception signal #S1 will be delivered to the second subject-side signal handling sub-unit 233b.

The subject-side signal control unit 231 passes the exception signal in turn to each of the specified group of signal handling sub-units 233.

Each of the subject-side signal handling sub-units 233 comprises an entry unit, a signal processing unit and an exit unit as discussed above for the target-side signal handling sub-units 223 with reference to FIG. 5. Thus, each subject-side signal handling sub-unit 233 receives the exception signal in turn according to the determined subject-side delivery path and selectively processes the exception signal. The relevant subject-side signal handling sub-unit 233 then requests either that the exception signal be passed on or that execution now return according to the (possibly modified) subject state 330.

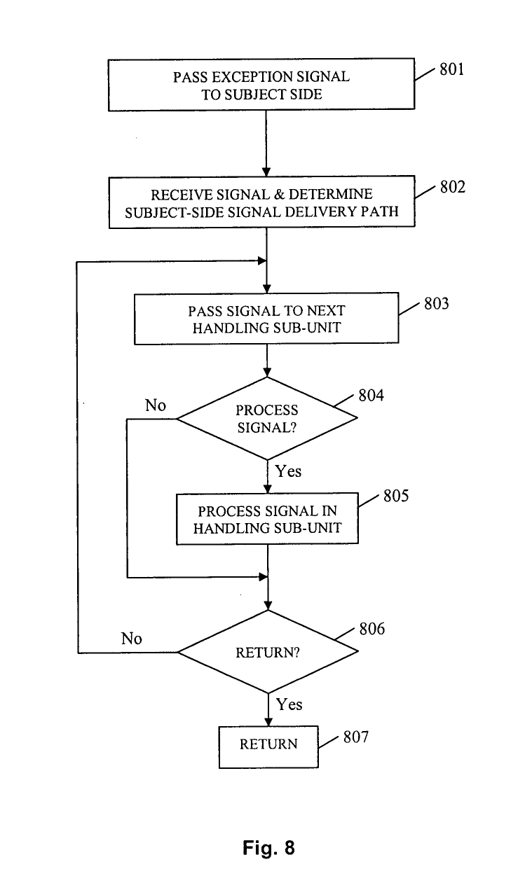

FIG. 8 is a schematic flow diagram illustrating an exemplary method of handling an exception signal in embodiments of the present invention. This method is performed in the exception handler unit 195 with respect to the subject-side exception handler unit 230.

Referring to FIG. 8, it is determined at step 801 to pass the exception signal to the subject-side exception handler unit 230.

Steps 802 through 807 are then similar to steps 601 through 606 discussed above for FIG. 6, whereby the subject-side exception handler unit 230 handles the exception in one or more of the available subject-side signal handling sub-units 233. At step 807 a return to execution is requested according to the subject state 330 which leads in turn to a corresponding target state 320 to resume execution of the target code 21 or the translator 19 as appropriate.

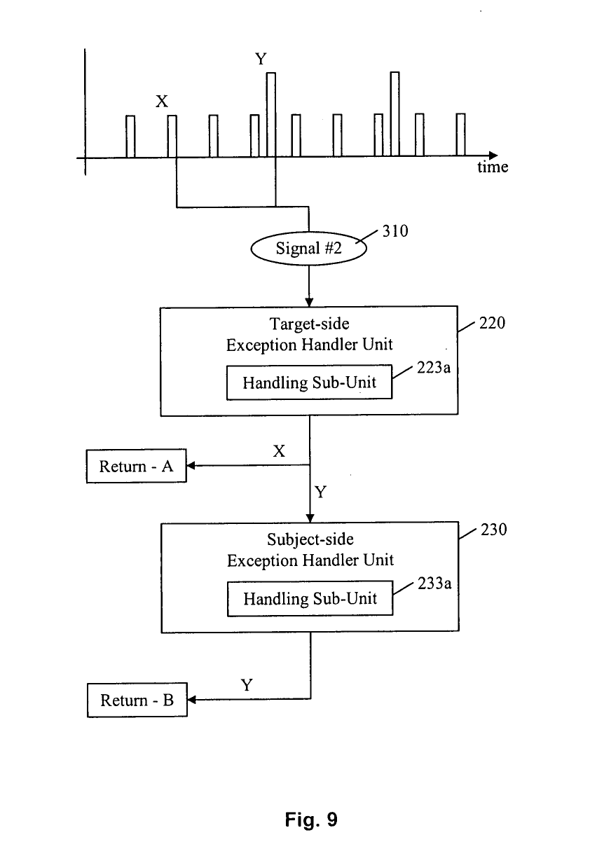

FIG. 9 is a schematic diagram showing the operations of the exception handling unit 195 in more detail. In particular, FIG. 9 provides a first illustrative example to assist those skilled in the art in gaining a full and detailed understanding of the invention. However, this illustrative example is just one of many exemplary embodiments which may be accomplished using the present invention.

In this first illustrative example, the exception handling mechanism discussed herein is particularly advantageous in relation to timing signals. As will be familiar to those skilled in the art, a program may set a timer which will cause an exception signal to be raised after a specified interval has elapsed. On POSIX-compliant platforms, popularly used timing signals include SIGALRM, SIGPROF and SIGVTALRM.

A problem arises in that many computing architectures provide only one of each such timing signal, whereas both the subject program (now running as target code 21) and the translator 19 may each need to make use of the same type of timing signal. For example, both the target code 21 and the translator 19 wish to use the SIGALRM exception signal. In this example as illustrated in FIG. 9, let us assume that the translator 19 is arranged to profile performance of the target code 21 at regular intervals of say every one second as illustrated by the letter X on the timeline. Also, let us assume that the subject program (now converted to the target code 21) is arranged uses the same type of timing signal to determine whether a user has pressed a key on the keyboard within a specified amount of time, such as 5 seconds, as shown by the letter Y on the timeline. The operating system 20 raises a SIGALRM type exception signal 310 which is passed initially to the target-side exception handler unit 220, at time X and at time Y. The delivery path for this type of signal indicates that the timing signal is delivered to a signal handling sub-unit 223a which now establishes whether the timing signal is expected by the target-side in this case by the translator 19. That is, the signal processing unit 225 comprises a frequency arbitrator unit that records expected timing signals and the owner of each expected signal. Thus, where event X gives rise to the signal, the signal handling sub-unit 223 determines that the signal 310 is owned by the translator 19. The signal is now handled and execution returns. By contrast, the exception signal at time Y is passed onto the subject-side exception handler unit 230, i.e. where it is determined that the signal was not expected by the target-side. The subject-side exception handler unit 230 determines an appropriate delivery path and routes the exception signal to a respective signal handling sub-unit 233a. Thus, an exception signal 310 arising from event Y now is received by the subject-side exception handler unit 230 and is handled as appropriate for the subject program.

From this example of FIG. 9 it will be appreciated that there are a number of advantages in the exception handling mechanism discussed herein. Firstly, a single type of exception signal—such as SIGALRM—is shared between code which relies on the target state 320 such as the translator 19 or the portions of control code 212 generated by the translator 19 and code which relies on the subject state 330 such as the main blocks 211 of the target code 21 which emulate the behaviour expected by the original subject program 17. Secondly, only those signals which are not needed by the target-side are passed on to the subject-side, thereby significantly reducing the number of occasions where the subject state 330 is precisely obtained.

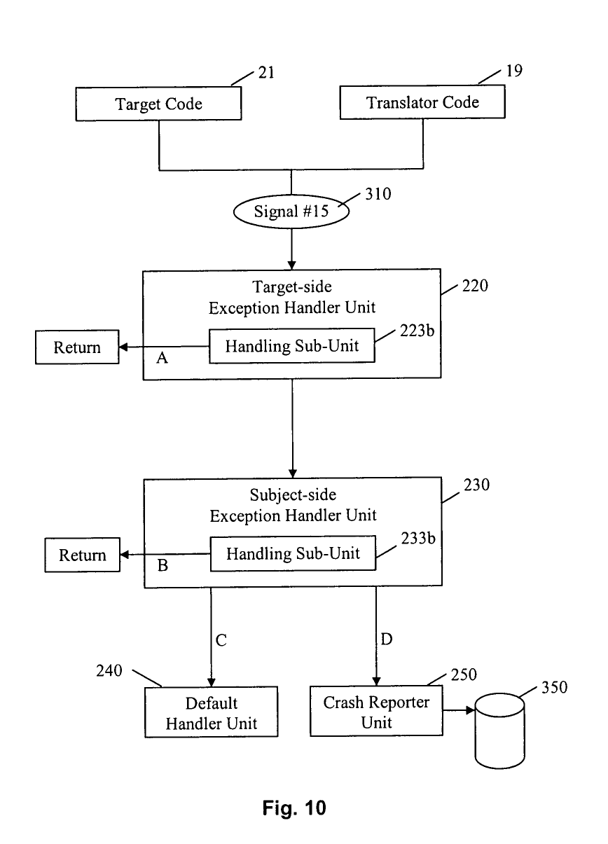

FIG. 10 is a schematic diagram showing operations of the exception handling unit 195 in more detail. As shown in FIG. 10, the exception handling unit 195 further comprises a default handler unit 240 and a crash reporter unit 250.

The default handler unit 240 is arranged to handle the exception signals according to the exception handling protocol of the target system. That is, the default handler unit 240 provides exception handling behaviour equivalent to the behaviour expected of the target operating system 20. Most commonly, the default behaviour is either to ignore the signal and return, or to terminate execution. An example of default behaviour is that a parent process receives a SIGCHLD exception signal for information when a child process is terminated, but in most cases the signal is ignored and execution continues.

The crash reporter unit 250 is provided as part of the translator code 19 and manages crashes of execution in an orderly manner, in particular to assist with debugging. Here, the crash reporter 250 is arranged to store state information, including for example the target state 320 and the subject state 330, in order to create a crash report data structure 350 containing detailed information concerning the state of execution relating to the crash. In example embodiments, the crash report data structure 350 is stored as a text file (.txt) in the memory system 18 of the target system.

FIG. 10 shows four main exception handling routes through the exception handling unit 195, here labelled “A” though “D”.

In route A, the exception is handled in one of the target-side exception handling sub-units 223 and returns to execution. In route B, the exception is handled in one of the subject-side exception handling sub-units 233 and returns to execution. In route C, the exception is handled in the default handling unit 240 and returns or terminates. In route D, the exception is handled in the crash reporter 250 and returns or terminates.

As shown in FIG. 10, the exemplary exception handling unit 195 is particularly advantageous in relation to the handling of floating point exceptions. Some computing architectures, for example those based on the IBM Power PC™ processor, do not raise an exception signal when a “divide by zero” illegal mathematical operation is attempted in the processor but instead set the result to zero and continue execution. By contrast, other computing architectures, such as those based on the Intel™ x86 processor, will raise an exception signal when the processor performs an illegal “divide by zero” operation. In FIG. 10, the target hardware is based on an x86 processor and therefore will produce such a floating point exception when an illegal divide by zero mathematical operation is encountered.

The exception will follow route A when this floating point exception arises through execution of the target code 21 generated by the translator 19 to perform the work of the subject program 17. That is, one of the signal handling sub-units 223b in the target-side exception handler unit 220 is arranged to receive the exception signal 310 and determine, such as by examining a program counter (PC) field in the SIGINFO data structure, that the exception arose from execution of the target code 21. The exception signal is now handled by resetting the result to zero, i.e. by modifying the content of one of the target registers as represented in the target state 320. Execution may now return to the target code 21 and continue. By resetting the result to zero, the target system will now correctly emulate the expected behaviour of this program according to the subject architecture. Also, the exception has been handled cheaply and, in particular, it has not been necessary to undergo the costly process of providing the subject state 330.

When the same type of floating-point exception signal arises from execution of the translator code 19, then this signal is now likely to represent a serious programming or execution error. Hence, the exception signal 310 now follows route C to the default handler unit 240 or route D to the crash reporter unit 250.

A further example of a frequently encountered exception signal is a segmentation fault (segfault) which indicates that an error has occurred where a program attempts to access memory in a way that is not allowed (e.g. attempting to write into a read-only protected memory area). On POSIX-type systems the symbolic constant for this type of fault is normally SIGSEGV. Such segmentation faults can arise for one of several different reasons and the same type of exception signal will, in different circumstances, make use of the different routes A-D through the exception handling unit 195.

Firstly, segmentation faults can be introduced on purpose as a trap to detect when the target code 21 is attempting to access a protected area of memory, such as an attempt to write into self-modifying code. The signal follows route A and the relevant target-side handling sub-unit 223 changes the target state 320 so that execution returns to the translator 19 to deal with this self-modifying code event. Thus, the translator 19 is able to rely on the exception handling unit to trap certain exception signals.

Secondly, the original subject code 17 has been written to use a segmentation fault as a trap. In this case the signal follows route B and is handled by one of the subject-side signal handling sub-units 233 to invoke a subject signal handling function with reference to the subject state 330.

Thirdly, the segmentation fault is passed to the exception handler unit 195 from another external process. Examining the field SI_CODE in the SIGINFO data structure determines whether the signal is external. In this case the signal follows route C where the default handler unit 240 performs the default behaviour which in this case is to ignore the signal.

Fourthly, a segmentation fault which was not expected and has not been captured by preceding units is passed to the crash reporter 250 following route D—on the basis that this signal has arisen from an unexpected error or bug in the translator.

Thus the same type of exception signal (in this case a segmentation fault) will follow any one of the available routes through the exception handling unit 195 according to the particular circumstances of that signal.

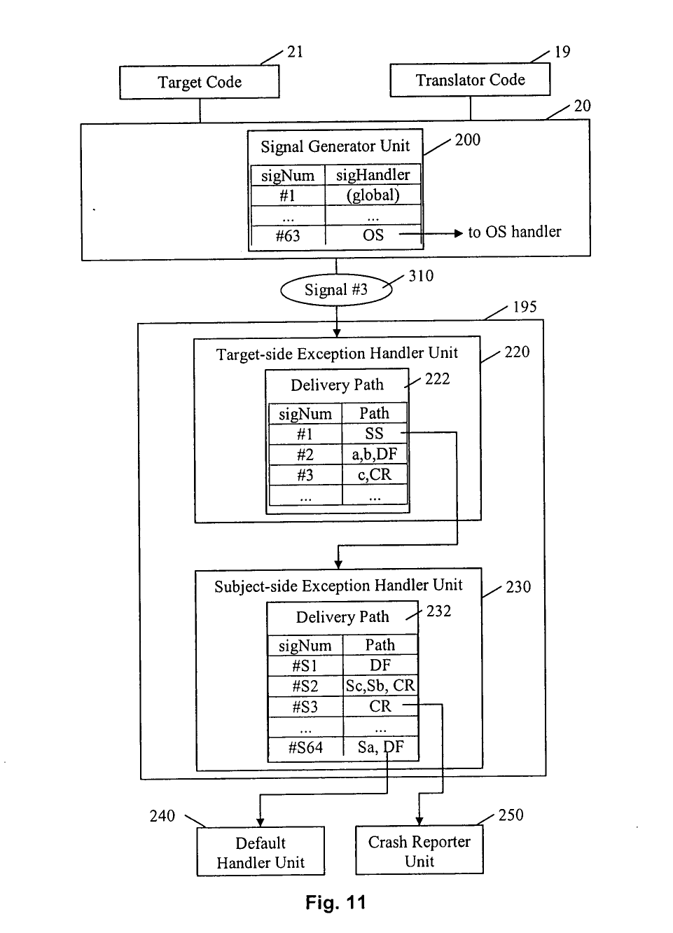

FIG. 11 is a schematic diagram showing the exception signal hander unit 195 in more detail in relation to the mechanism which directs the passing of exception signals.

As will be familiar to those skilled in the art, some types of exception signals (e.g. SIGKILL) are not capable of being intercepted and are always handled by the operating system 20. In FIG. 11, the signal type #63 is shown as an example of such a non-interceptable exception signal.

However, there are many types of exception signal in the target architecture that are interceptable and, in the exemplary embodiments, the exception handler unit 195 is registered to receive all types of signals on the target architecture which are capable of being intercepted. Here, at least signal types #1, #2 and #3, etc. are capable of being intercepted and the exception signal handling unit 195 is thus registered to receive such signals. In FIG. 11, the signal generator unit 200 in the operating system 20 records the notation “(global)” to show that such signals are to be delivered not to the signal handling elements of the operating system 20 but instead to the exception handler unit 195 of the exemplary embodiments discussed herein.

The delivery path selection unit 222 of the target-side exception handler unit 220 determines that some types of exception signals are passed to the default handler unit 240, as marked with the letters “DF”, or the crash reporter “CR” either directly or after first passing the exception signal through one or more of the target-side signal handling sub-units 223 (see FIG. 4). In FIG. 11 the letters “a”, “b” or “c” refer to selected ones of the target-side signal handling sub-units 223. Further, some types of exception signal are passed to the subject-side exception handler unit 230 as marked with the letters “SS”, again either directly or after first passing the exception signal through one or more of the target-side signal handling sub-units “a”, “b”, “c”, etc. This determination is conveniently recorded in a table as illustrated in FIG. 11. However, some types of signal such as the segmentation fault discussed above require additional processing to make an appropriate determination, such as examining the SIGINFO or SIGCONTEXT data structures.

Similarly, the delivery path selection unit 232 of the subject-side exception handler unit 230 is configured to selectively pass certain exception signals to the default handler unit 240 as shown with the letters “DF” or the crash reporter unit 250 shown as “CR”, either with or without first passing the exception signal through one or more subject-side signal handling sub-units 233 as shown here by the letters “Sa”, Sb” or “Sc”.

Thus, the delivery path selection units 222,232 provide a simple and convenient mechanism to route each particular type of exception signal along a respective predetermined delivery path.

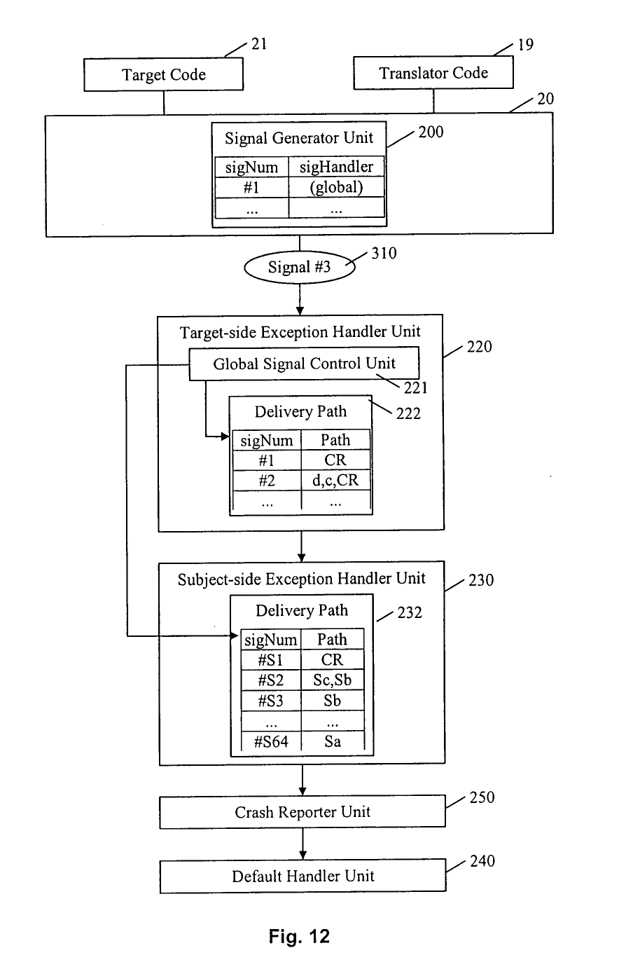

FIG. 12 is a schematic diagram illustrating the exemplary exception handling mechanism in more detail in relation to dynamic reconfiguration of signal delivery paths.

As shown in FIG. 12, the global signal control unit 221 is configured to dynamically control the target-side delivery path selection unit 222 and the subject-side delivery path selection unit 232. That is, the global signal control unit 221 is arranged to add, amend or replace the specified delivery path for one or more of the types of exception signals. In this way, the global signal control unit 221 will add, amend or replace the set of signal handling sub-units 223, 233 which are to receive a particular type of exception signal and the specified order of the delivery path.

Further, the crash reporter unit 250 is arranged to work in combination with the global signal control unit 221 to dynamically reconfigure the delivery paths. As an example, the crash reporter unit 250 is arranged to introduce an additional bus error signal handling sub-unit where an exception signal has been raised indicating that a particular area of memory is not mapped. This newly introduced bus error sub-unit performs a memory mapping function and returns to execution. If the fault occurs again, the bus error sub-unit will now help to recover more detailed information concerning the target state 320 and/or the subject state 330 and then continue to a subsequent part of the crash reporting process. Thus, the crash reporter unit maintains control of execution and can introduce a bespoke set of signal handling sub-units to handle exception signals.

In these embodiments, the signal table held by the signal generator unit 200 of the target operating system 20 is not updated, even though new exception signal handling behaviour has been introduced within the exception handling unit 195. That is, the set of signal handling sub-units is added to, amended or replaced, without requiring a system call to register the newly set of signal handling sub-units. Thus, the exception handling unit 195 is both flexible and powerful whilst being cheap and efficient to operate.

As discussed above, the exemplary exception handling mechanism of the present invention has many advantages. The mechanism reduces the amount of work which must be done in response to each exception signal, not least because many signals are successfully handled by the target-side exception handling sub-units quickly and cheaply. In many cases the exception signal is handled without the cost of obtaining a subject state representing an equivalent point in execution of the original subject code. Further, the mechanism is able to share one exception signal amongst both target code execution and translator code execution and thereby improve efficiency of operation on the target computing architecture. The mechanism alleviates the sometimes substantial differences that arise between exception handling on a subject computing architecture against exception handling on the target architecture and thus assists the target architecture to better support execution of the subject code. This is vitally important in the field of dynamic translation and especially dynamic binary translation where it is desired to automatically convert program code without any human intervention. Providing multiple subject-side exception handling sub-units allows for easy and efficient mapping of the available exception signals from the target system to the set of subject exception signals required by the subject code. Even where the subject code makes extensive use of signals, the required number or type of signals are now readily supported on the target computing platform. Finally, the exemplary mechanism provides dynamic flexibility and control over the handling of exception signals including especially the ability to provide multiple signal handling sub-units that each receive the same exception signal and the ability to add, amend or replace those units with minimal overhead.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computing system, comprising:
a translator unit arranged to convert subject code into target code;
a processor unit arranged to execute the target code and provide a target state with respect to execution of the target code in the processor unit;
a signal generator unit arranged to generate exceptional signals at least in response to execution of the target code in the processor unit; and
an exception handling unit comprising
a target-side exception handler unit arranged to receive one of the exception signal from the signal generator unit and to selectively handle the exception signal with respect to the target state; and
a subject-side exception handler unit arranged to receive the exception signal from the target-side exception handling unit and to handle the exception signal with respect to a subject state derived from the target state, wherein the subject state represents execution of the subject code on a subject processor unit;
wherein the target-side exception handler unit comprises:
a plurality of signal handling sub-units each arranged to selectively process the exception signal with respect to the target state and output a request either to return to execution or to pass on the exception signal;
a delivery path selection unit arranged to determine a delivery path of the exception signal to a selected group of the plurality of signal handling sub-units; and
a signal control unit arranged to deliver the exception signal in turn to each of the selected group of signal handling sub-units according to the delivery path and (i) where a respective one of the signal handling sub-units requests the return to execution then to return to execution according to the target state; and (ii) where the signal handling sub-unit requests to pass on the exception signal then to pass on the exception signal to a subsequent one of the selected group of signal handling sub-units according to the delivery path and, where no further of the signal handling sub-units are specified in the delivery path, to deliver the exception signal to the subject-side exception handler unit.

2. The computing system of claim 1, wherein signal generator unit generates the exception signals as one of a plurality of different types and the delivery path selection unit determines the delivery path according to the type of the exception signal.

3. The computing system of claim 1, wherein the delivery path selection unit comprises a table which maps a set of different types of the exception signals each to a respective group of the signal handling sub-units.

4. The computing system of claim 1, wherein the signal generator unit is arranged to generate the exception signals having a plurality of different types and the delivery path selection unit comprises a table which maps each type of the exception signals to a respective group comprising none, one or more of the signal handling sub-units and including at least one group comprising a plurality of the signal handling sub-units.

5. The computing system of claim 1, wherein the signal generator unit is arranged to generate at least some of the exception signals which are interceptable and the exception handling unit is registered with the signal handling unit to receive at least some of the exception signals which are interceptable.

6. The computing system of claim 1, wherein the delivery path selection unit determines the delivery path to specify an order of delivery of the exception signal to the selected group of signal handling sub-units, and the signal control unit delivers the exception signal to the selected group of signal handling sub-units in order according to the order of delivery.

7. The computing system of claim 1, wherein:
the processor unit is arranged to execute the translator unit and the target code and to provide the target state representing a current state of execution in the processor unit in relation to one of the target code and the translator unit;
the signal generator unit is arranged to generate the exception signals in relation to the target code and in relation to the translator unit; and
at least one of the signal handling sub-units is arranged to handle the exception signal with respect to the target state when the exception signal results from execution of the translator unit.

8. The computing system of claim 7, wherein:
at least one of the signal handling sub-units is arranged to process the exception signal with respect to the target state when the exception signal results from execution of the target code.

9. The computing system of claim 7, wherein the subject-side exception handler is arranged to handle the exception signal with respect to the subject state derived from the target state when the exception signal results from execution of the target code.

10. The computing system of claim 1, wherein:
the delivery path selection unit determines the delivery path for at least one type of the exception signals to include the subject-side exception handler unit; and
the signal control unit delivers the exception signal to the subject-side exception handler unit according to the delivery path.

11. The computing system of claim 10, wherein the signal control unit delivers the exception signal to the subject-side exception handler unit after delivering the exception signal to each of a selected group of the signal handling sub-units, according to the delivery path.

12. The computing system of claim 1, wherein the exception handling unit further comprises:
a crash reporter unit arranged to generate and store a crash report data structure concerning the state of execution of the processor unit relating to a crash following the exception signal, and return to execution or terminate execution; and/or
a default handler unit arranged to handle the exception signal according to a predetermined exception handling protocol and return to execution or terminate execution; and
the delivery path selection unit determines the delivery path to include the crash reporter unit and/or the default handler unit; and
the signal control unit delivers the exception signal to the crash reporter unit and/or the default handler unit according to the delivery path.

13. The computing system of claim 12, wherein the signal control unit delivers the exception signal to the crash reporter unit and/or the default handler unit after delivering the exception signal to each of a selected group of the signal handling sub-units and to the subject-side exception handler unit, according to the delivery path.

14. The computing system of claim 1, wherein each of the plurality of signal handling sub-units comprises:
an entry unit arranged to receive the exception signal and determine whether or not to process this exception signal;
a signal processing unit arranged to perform a predetermined signal processing function on the exception signal with respect to the target state when determined by the entry unit, including selectively modifying the target state such that execution will resume differently in response to the exception signal; and
an exit unit arranged to output the request either to return to execution or to pass on the exception signal.

15. The computing system of claim 14, wherein the target state includes a signal information data structure containing information relating to the exception signal.

16. The computing system of claim 14, wherein the target state includes a signal context data structure containing information relating to a context of the processor unit with respect to the exception signal.

17. The computing system of claim 1, wherein the subject-side exception handler comprises:
a converter unit arranged to convert the target state into the subject state;
a plurality of subject-side signal handling sub-units each arranged to selectively process the exception signal with respect to the subject state and determine either to pass on the exception signal or request a return to execution;
a subject-side delivery path selection unit arranged to determine a delivery path of the exception signal where the delivery path specifies a selected group of one or more amongst the plurality of subject-side signal handling sub-units; and
a subject-side signal control unit arranged to pass the exception signal in turn to each of the selected group of subject-side signal handling sub-units and return to execution in response to the request from a respective one of the group of subject-side signal handling sub-units.

18. The computing system of claim 17, wherein the converter is further arranged to reconvert the subject state into the target state when the subject-side signal control unit determines to return to execution.

19. The computing system of claim 17, wherein each of the plurality of subject-side signal handling sub-units comprises:
an entry unit arranged to receive the exception signal and determine whether or not to process this exception signal;
a signal processing unit arranged to perform a predetermined signal processing function on the exception signal with respect to the subject state when determined by the entry unit, including selectively modifying the subject state such that execution will resume differently in response to the exception signal; and
an exit unit arranged to output the request either to return to execution or to pass on the exception signal.

20. The computing system of claim 18, wherein the subject state includes a subject signal information data structure containing information relating to a converted form of the exception signal.

21. The computing system of claim 20, wherein the subject state includes a subject signal context data structure containing information relating to a context of the emulated subject processor with respect to the converted form of the exception signal.

22. The computing system of claim 1, wherein the signal control unit is arranged to dynamically reconfigure the delivery path selection unit to determine a different delivery path for the exception signal.

23. The computing system of claim 22, wherein the signal control unit is arranged to reconfigure the delivery path selection unit to add, amend or replace the delivery path for a particular type of the exception signal.

24. The computing system of claim 23, wherein the signal control unit is arranged to reconfigure the delivery path selection unit to add, amend or replace one or more of the signal handling sub-units in the selected group according to the delivery path for a particular type of the exception signal.

25. The computing system of claim 1, wherein the subject code is binary program code which is directly executable by a processor.

26. The computing system of claim 1, wherein the target code is binary program code which is directly executable by the processor unit.

27. The computing system of claim 1, wherein the translator unit is arranged to convert the subject code being binary program code which is directly executable by a processor of a first type into the target code being binary program code which is directly executable by the processor unit.

28. The computing system of claim 1, wherein the translator unit is arranged to translate the subject code written for execution by a processor of a first type into the target code executed by the processor unit of a different non-compatible second type.

29. The computing system of claim 1, wherein the translator unit is arranged to optimise the subject code written for execution by a processor of a first type into the target code that is executed more efficiently by the processor unit of the same first type.

30. A method of handling an exception signal in a computing system having at least one processor, the method comprising the computer-implemented steps of:
converting subject code executable into target code executable by the at least one processor;
executing the target code on the at least one processor;
generating an exception signal in relation to execution of the target code;
determining a signal delivery path with respect to the exception signal where the signal delivery path specifies a group of signal handling sub-units selected from amongst a plurality of signal handling sub-units;
delivering the exception signal to a first of the signal handling sub-units in the group according to the signal delivery path;
determining whether to process the signal in the signal handling sub-unit and if so then processing the signal in the signal handling sub-unit to handle the exception; and
deciding whether to request a return to execution and if so then returning to execution, or else passing the exception signal to a next signal handling sub-unit of the group according to the signal delivery path and repeating the determining and deciding steps in relation to the next signal handling sub-unit.

31. The method of claim 30, further comprising:
providing a target state data structure containing information relating to a state of execution of the computing system concerning the exception signal;
processing the exception signal in the signal handling sub-unit with reference to the target state data structure signal including selectively modifying the target state data structure; and
where the deciding step decides to request a return to execution then returning to execution according to the target state data structure.

32. The method of claim 31, further comprising:
selectively passing the exception signal to a subject-side exception handling unit;
converting the target state data structure into a subject state data structure; and
handling the exception signal with respect to the subject state data structure in the subject-side exception handling unit.

33. A method of handling an exception signal in a computing system having at least one processor, the method comprising the computer-implemented steps of:
converting subject code executable by a subject processor type into target code executable by at least one processor;
executing the target code in the at least one processor;
generating an exception signal in relation to the executing of the target code by the at least one processor;
determining whether or not to handle the exception signal solely with reference to a target state data structure containing information representing a state of execution of the computing system in relation to the exception signal; and
if not, then converting the target state data structure into a subject state data structure containing information representing an emulated state of execution of the subject code on the subject processor type relating to the exception signal and handling the exception signal with respect to the subject state data structure.

34. A computer readable recording medium having instructions recorded thereon which when executed by a computing system having at least one processor cause the computing system to perform at least the steps of:
converting subject code executable into target code executable by the at least one processor;
executing the target code on the at least one processor;
generating an exception signal in relation to execution of the target code;
determining a signal delivery path with respect to the exception signal where the signal delivery path specifies a group of signal handling sub-units selected from amongst a plurality of signal handling sub-units;
delivering the exception signal to a first of the signal handling sub-units in the group according to the signal delivery path;
determining whether to process the signal in the signal handling sub-unit and if so then processing the signal in the signal handling sub-unit to handle the exception signal; and
deciding whether to request a return to execution and if so then returning to execution from handling of the exception signal, or else passing the exception signal to a next signal handling sub-unit of the group according to the signal delivery path and repeating the determining and deciding steps in relation to the next signal handling sub-unit.

35. The computer readable recording medium of claim 34, wherein said instructions further cause the computing system to perform the steps of:
providing a target state data structure containing information relating to a state of execution of the computing system concerning the exception signal;
processing the exception signal in the signal handling sub-unit with reference to the target state data structure signal including selectively modifying the target state data structure; and
where the deciding step decides to request a return to execution then returning to execution according to the target state data structure.

36. The computer readable recording medium of claim 35, wherein said instructions further cause the computing system to perform the steps of:
selectively passing the exception signal to a subject-side exception handling unit;
converting the target state data structure into a subject state data structure; and
handling the exception signal with respect to the subject state data structure in the subject-side exception handling unit.

37. A computer readable recording medium having instructions recorded thereon which when executed by a computing system having at least one processor cause the computing system to perform at least the steps of:
converting subject code executable by a subject processor type into target code executable by the at least one processor;
executing the target code in the at least one processor;
generating an exception signal in relation to execution of the target code by the at least one processor;
determining whether or not to handle the exception signal solely with reference to a target state data structure containing information representing a state of execution of the computing system in relation to the exception signal; and
if not, then converting the target state data structure into a subject state data structure containing information representing an emulated state of execution of the subject code on the subject processor type relating to the exception signal and handling the exception signal with respect to the subject state data structure.
